(19) United States
(12) Patent Application Publication
(10) Pub. No.: US 2022/0227651 A1
(43) Pub. Date: Jul. 21, 2022

(54) COMPOSITIONS AND METHODS FOR TREATING AND RECLAIMING PAINT FLUSH WASTE

(71) Applicant: Heritage Research Group, LLC, Indianapolis, IN (US)

(72) Inventor: Anthony Rogers, Brownsburg, IN (US)

(73) Assignee: Heritage Research Group, LLC, Indianapolis, IN (US)

(21) Appl. No.: 17/650,725

(22) Filed: Feb. 11, 2022

Related U.S. Application Data
(63) Continuation of application No. PCT/US2020/046056, filed on Aug. 13, 2020.
(60) Provisional application No. 62/885,866, filed on Aug. 13, 2019.

(51) Int. Cl. C02F 9/00; C09D 7/00; B01D 37/02; B01D 37/03

(52) U.S. Cl. CPC C02F 9/00; C09D 7/71; C02F 1/5236; B01D 37/03; B01D 37/02

(57) ABSTRACT

Methods and compositions useful for cleaning the lines used during manufacturing processes are disclosed. In certain embodiments, the methods and compositions may be particularly useful in the manufacture of colored paints or coatings or in the use of colored paints or coatings, for example, in the manufacture of finished automobiles.

### CROSS-REFERENCE TO RELATED APPLICATION(S)

This application is a continuation of International Application No. PCT/US2020/046056 filed Aug. 13, 2020, which claims the benefit of U.S. Provisional Application No. 62/885,866 filed Aug. 13, 2019, both of which are hereby incorporated herein by reference in their entirety.

### BACKGROUND

Manufacturers, such as paint manufacturers and/or automobile manufacturers who use or manufacture paints, may flush their systems between color changes so as to minimize waste and contamination of their equipment and products. Barium has been used in increased concentrations in paint formulations recently, which may trigger regulatory restrictions on how the waste is treated or otherwise disposed. Therefore, there remains a need for improved methods and compositions for flushing systems and treating waste streams from these systems.

### SUMMARY

In some embodiments, the waste stream generated from cleaning or flushing of manufacturing equipment is treated so that paint solids (e.g., inorganics) and/or organic compounds from the paint formulations are removed from the composition used to clean or flush the manufacturing equipment. In certain embodiments, the composition used to clean or flush the manufacturing equipment is a waterborne purge solution.

In other embodiments, the waterborne purge solution used to clean or flush the manufacturing equipment is treated by raising the pH of the composition, lowering the pH of the composition, or using an oxidizer such as bleach. In some embodiments, a strong base such as, but not limited to, sodium hydroxide or lime is used. In still other embodiments, a waterborne purge or spent purge solvent may be treated with an ion-exchange resin.

In one embodiment, manufacturing equipment is cleaned or flushed by the use of a waterborne purge solution. In some embodiments, the waterborne purge solution used is a water/solvent mixture, sometimes called, DI Purge or Hydropurge. In certain embodiments, the waterborne purge solution comprises water; an organic solvent; an ether; a glycol; a glycol ether; a surfactant; an ethanolamine; an alcohol; an ester; a ketone; poly(oxy-1,2-ethanediyl), a-hexyl-w-hydroxy-; monoethanolamine; benzyl alcohol; tris(2-butoxyethyl)phosphate; or a combination thereof.

In another embodiment, the colored paint formulation used in manufacturing equipment is cleaned out or flushed from the manufacturing equipment prior to the use of a different color formulation in the manufacturing equipment.

In some embodiments, a filter aid is used to improve the filterability or dewatering of the solids in the waste stream. In certain embodiments, the filter aid is diatomite, diatomaceous earth, perlite, and/or cellulose.

Additional embodiments of the invention, as well as features and advantages thereof, will be apparent from the descriptions herein.

### BRIEF DESCRIPTION OF THE DRAWINGS

FIG. 1 is a process flow diagram of one embodiment of the present disclosure showing spent solvent purge as the starting material for the process undergoing a pH adjustment with an acid and/or a base, a filtration and/or separation process giving paint solids and a supernatant that can undergo neutralization or another pH adjustment step with acid and/or base to provide reclaimed purge solution.

FIG. 2 is a process flow diagram of one embodiment of the present disclosure showing spent solvent purge as the starting material for the process undergoing a pH adjustment with an acid, a filtration and/or separation process giving paint solids and a supernatant that can undergo neutralization or another pH adjustment step with a base to provide reclaimed purge solution.

FIG. 3 is a process flow diagram of one embodiment of the present disclosure showing spent solvent purge as the starting material for the process where lime is added to precipitate paint solids, a filtration and/or separation step to provide paint solids and a supernatant that can undergo a neutralization or pH adjustment step by addition of CO₂, another filtration and/or separation step to provide solids and a reclaimed purge solution.

FIG. 4 shows a digital image of treated spent purge solvent after filtering paint solids, but before an act of neutralization, with ion exchange resin.

FIG. 5 shows a digital image of treated spent purge solvent after neutralization, with ion exchange resin.

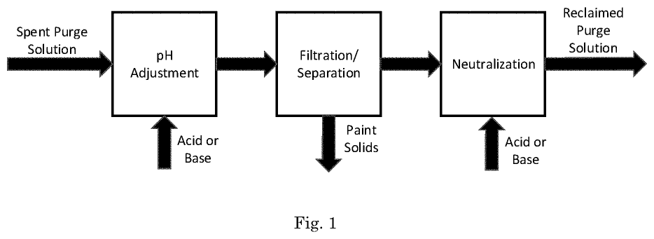

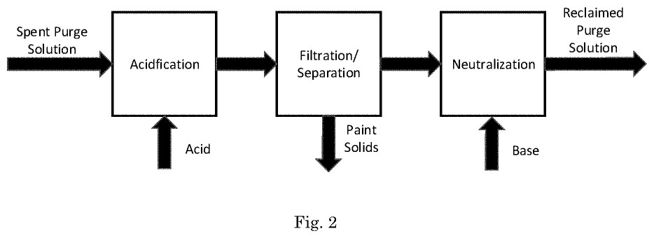

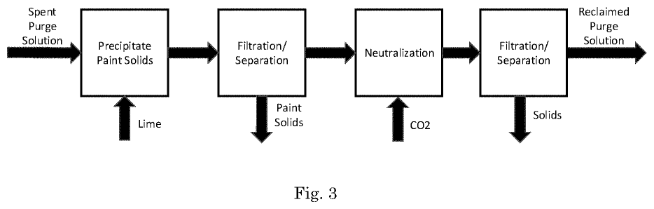

### DETAILED DESCRIPTION

For the purposes of promoting an understanding of the principles of the invention, reference will now be made to certain embodiments and specific language will be used to describe the same. It will nevertheless be understood that no limitation of the scope of the invention is thereby intended, such alterations and further modifications, and such further applications of the principles of the invention as described herein being contemplated as would normally occur to one skilled in the art to which the invention relates. Additionally, in the detailed description below, numerous alternatives are given for various features. It will be understood that each such disclosed alternative, or combinations of such alternatives, can be combined with the more generalized features discussed in the Summary above, or set forth in the embodiments described below to provide additional disclosed embodiments herein.

During the manufacture of paints or other coatings with color, the manufacturing systems or apparatus may need to be cleaned when switching between colors so as to minimize contamination between the colors For example. Some manufacturers flush the lines of the manufacturing equipment with water-based low volatile organic compound (VOC) systems. One example includes a waterborne purge solvent concentrate used by some manufacturers is called Hydropurge®. Hydropurge can be purchased as a concentrate that is diluted with water to form a waterborne purge solution which is then flushed through the lines once. For example, Hydropurge concentrate may be diluted as 9 part water and 1 part Hydropurge concentrate to form a waterborne purge solution which is used to flush the lines of manufacturing equipment. Other waterborne purge solvents can be used such as DI Purge.

After a purge composition is flushed through the lines, this generates a waste stream containing the purge composition used to flush the lines as well as materials (e.g., paint) that were removed from the line. Typically, the resulting waste stream has between about 1% to about 5% of material that was removed from the line. This may include barium that is flushed from the line and which can be present in quantities from about 0.001% to about 0.002%, or from about 0.00125% to about 0.0014%. Materials flushed from the lines can include, but is not limited to, dyes or pigments; metals such as barium; and/or organic compounds such as, but not limited to, acrylics, acrylic enamels, and/or urethanes. When used, barium may be in any form, such as elemental barium, barium oxide, barite or baryte, barium sulfate, witherite or barium carbonate, barium nitrate, or another salt of barium.

Some materials used in paints or other coatings may be regulated. For example, compositions with a certain level of barium may require special handling and or treatment prior to their final disposition. Therefore, it may be advantageous to have a recycling or treatment process that can be used to remove such compounds from waste streams. In some embodiments of the present disclosure, such a recycling or treatment process can be onsite at the manufacturing facility. In other embodiments, the recycling or treatment process may be performed at a facility some distance away from the manufacturing facility where the waste stream originated.

In certain embodiments, the paint formulations described herein may comprise at least one organic component and at least one inorganic component. In certain embodiments, the organic components may be dissolved in a phase of the waste stream, while the inorganic components may be suspended solids. In certain embodiments, it has been surprisingly discovered that altering the pH of the waste stream can effectively (i) floc the suspended inorganic paint components (e.g., undesirable metals such as barium), and (ii) precipitate the organic paint components(s), thereby resulting in the removal of both components from the waste stream through the formation of a mass of paint solids. Without being bound to any particular theory, it is believed that the floccing effect may be the result of a solid base (e.g., lime) acting as a substrate for flocculation. In other embodiments, and still without being bound to any particular theory, it may be calcium which affects or improves the observed floccing effect.

Solid waste from some manufactures contains a level of leachable barium that would require the waste to be treated as hazardous waste. The Environmental Protection Agency (EPA) regulates wastes, including listing various wastes in lists. These lists include the D List, the F List, the K List, the P List, and the U List. The EPA lists Barium, chemical symbol “Ba”, with Hazardous Waste Code “D005” on the D List with a regulated level of 100.0 mg/L or ppm.

Waste streams after treatment according to the methods disclosed and claim typically have a concentration of barium of about 1 ppm, below about 1 ppm, below about 10 ppm, below about 50 ppm, below about 75 ppm, or below about 100 ppm as measured by the Toxicity Characteristic Leaching Procedure (TLCP). TLCP is also known as EPA Method 1311, which is hereby incorporated by reference herein in its entirety. EPA Method 6010D (ICP-OES or Inductively Coupled Plasma—Optical Emission Spectroscopy), which is also hereby incorporated by reference herein in its entirety, is often used in conjunction with EPA Method 1311 as a detection method. When the term TLCP is used herein it can refer to EPA Method 1311 along, EPA Method 1311 used in conjunction with EPA Method 6010D, or EPA Method 1311 used in conjunction with another method.

Any acid may be used in embodiments of the present disclosure. Strong acids may be used in embodiments of the present disclosure and weak acids can be used in embodiments of the present disclosure. Examples of acids that may be used include, but are not limited to, sulfuric acid, phosphoric acid, nitric acid, hydrochloric acid, methane sulfonic acid, formic acid, acetic acid a conjugate acid of a weak base, or an acidic waste stream. When an acid is used, it may be used to adjust the pH of a composition to a neutral or an acidic pH, for example, but not limited to about 3 to about 5, about 4, about 5 to about 9, about 6 to about 8, and/or about 7.

Any base may be used in embodiments of the present disclosure. String bases may be used in embodiments of the present disclosure and weak bases may be used in embodiments of the present disclosure. Examples of bases that may be used include, but are not limited to lithium hydroxide, sodium hydroxide, potassium hydroxide, magnesium hydroxide, calcium hydroxide, ammonia, ammonium hydroxide, or a conjugate base of a weak acid, or a basic waste stream. When a base is used, it may be used to adjust the pH of a composition to a neutral or a basic pH, for example, but not limited to about 10 to about 14, about 11 to about 13, about 12, about 12.2, about 5 to about 9, about 6 to about 8, and/or about 7.

Oxidizers may be used in embodiments of the present disclosure. Examples of oxidizers that may be used include, but are not limited to bleach, hypochlorite, chloramine, a permanganate, ozone, or hydrogen peroxide.

Filter aids may include, but are not limited to, diatomite, diatomaceous earth, perlite, and/or cellulose.

In order to promote a further understanding of the present invention and its various embodiments, the following specific examples are provided. It will be understood that these examples are illustrative and not limiting of the invention.

### Example 1

### Flushing Manufacturing Equipment Lines to Change Compositions

An emulsion is formed by diluting 1 part Hydropurge® Concentrate with 9 parts water for form a waterborne purge solution. A quantity of this emulsion is then flushed through lines of the manufacturing equipment used to manufacture or apply a composition comprising one or more dyes or pigments. The composition may include other compounds including, but not limited to barium, barium salts, organic compounds, inorganic compounds, metallic flakes, iridescent pigments or pearls. After flushing of the manufacturing equipment, the resulting waste stream suspension that comprises one or more dyes or pigments, as well as other compounds used in the composition. A new composition to be manufactured or applied is then introduced into the manufacturing equipment.

### Example 2

### Treatment of Composition Used to Flush the Lines of Manufacturing Equipment

As noted above, the waste stream that results from flushing the lines of manufacturing equipment may comprise a suspension containing one or more dyes or pigments, as well as other compounds used in the composition after washing or flushing the manufacturing equipment. This suspension is broken/separated by adding 1% by weight lime to raise the pH. Solid lime is left in suspension which acts as a flocking agent for the one or more dyes, pigments, or other organics to adhere to. 0.5 weight percent of filter aid is added and the composition is mechanically agitated. The composition is then filtered with a plate and frame filter press. The solid is collected and disposed of. The liquid filtrate is then disposed of, or, alternatively, the pH of the filtrate is neutralized by bubbling CO₂ through the filtrate. Once the pH of the filtrate has been neutralized, the filtrate is then used to flush the manufacturing equipment again.

### Example 3

### Treatment of Waste Stream Comprising an Emulsion

The emulsified waste stream with a pH between about 5 and about 9 was broken by the addition of a 1 percent by weight of lime and raised the pH to 12.2. The composition was allowed to mix for 10 minutes. 0.5% by weight of Perlite was added to the mixture and allowed to mix for an additional 10 minutes. After the emulsion/mixture finished mixing, the paint materials present and excess solid lime was separated by filtration using a Buchner funnel and vacuum filtering. The solid which included paint materials and solid lime had a barium concentration of 1 ppm barium as measured by TCLP, and was disposed of as solid non-hazardous landfill waste. The composition of this solid as measured by XRF is shown in Table 1.

TABLE 1
Composition of a solid waste as measured
by X-Ray Fluorescence (XRF).

| | Quantity |
|---|---|
| Constituent | (by weight) |
| Ca | 21.8% |
| Ti | 9.8% |
| Si | 7.1% |
| Al | 2.0% |
| K | 0.92% |
| Fe | 0.67% |
| Ba | 0.14% |

The pH of the filtrate was then modified to 6.8 by addition of carbon dioxide by bubbling in CO₂ using a diffusing stone. CaCO₃ was formed during and after addition of carbon dioxide, and the precipitate was removed by filtration.

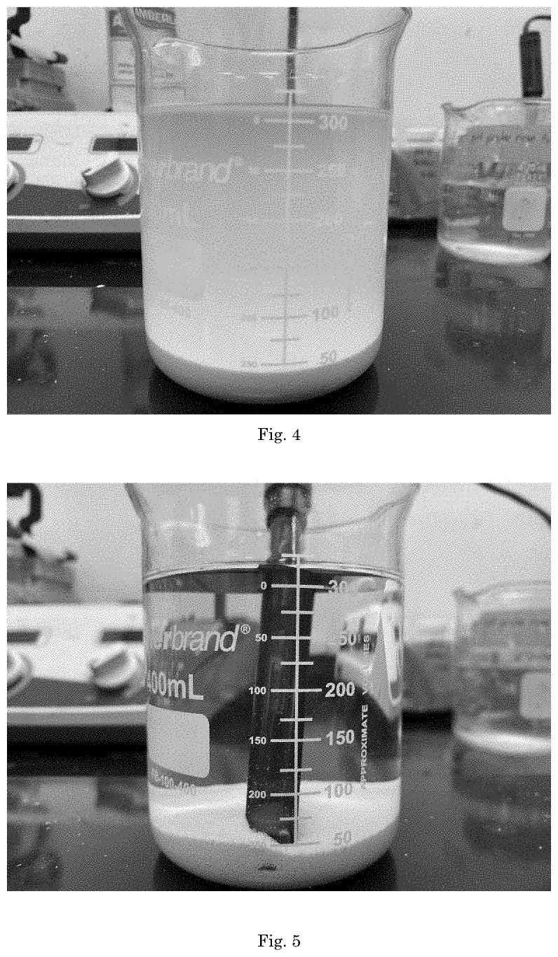

In another embodiment, an ion-exchange resin may be used in addition to, or instead of a neutralization step. In such embodiments, when used, an ion-exchange resin may neutralize the acid or base by removing the associated anions or cations (for example, but not limited to, Cl⁻, SO₄²⁻, Ca²⁺, Na⁺) and by forming water with the associate hydroxide or hydrogen ion. When an ion-exchange resin is used and without being bound by theory, the use of an ion-exchange resin may have the benefit of not leaving dissolved solids and/or salts in the solvent-water mixture. Such solids and/or salts may build up over time and affect solvency, limit how much material may be recycled due to the risks of precipitates falling out of solution, and also does not require complicated equipment and additional reagents, and/or additional filtrations steps in the process. The ion-exchange resin could then be regenerated by methods known to one of ordinary skill in the art and reused. When an ion-exchange resin is used, the process may result in a brine waste stream that can be sent to a publically owned water treatment (POWT) plants or waste water treatment plants. FIG. 4 shows a digital image of spent purge solvent after filtering out paint solids, but before neutralization, with ion-exchange resin at the bottom of the beaker. FIG. 5 shows a digital image of spent purge solvent after neutralization with ion-exchange resin at the bottom of the beaker.

The uses of the terms “a” and “an” and “the” and similar references in the context of describing the invention (especially in the context of the following claims) are to be construed to cover both the singular and the plural unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

While the invention has been illustrated and described in detail in the drawings and the foregoing description, the same is to be considered as illustrative and not restrictive in character, it being understood that only the preferred embodiment has been shown and described and that all changes and modifications that come within the spirit of the invention are desired to be protected. In addition, all references cited herein are indicative of the level of skill in the art and are hereby incorporated by reference in their entirety.

1-26. (canceled)

27. A method for switching paint formulations in a manufacturing process from a first color formulation to a second color formulation, said first color formulation comprising at least one suspended inorganic paint component and at least one dissolved organic paint component, the method comprising the acts of:
flushing lines containing the first color formulation with a first composition to provide a second composition wherein said second composition comprises the suspended inorganic paint component and the dissolved organic paint component;
floccing the inorganic paint component and precipitating the organic paint component to provide a composition comprising a liquid portion and paint solids;
separating the paint solids from the liquid portion of the second composition to provide a solid portion; and
introducing a second color component into the lines of the manufacturing process.

28. The method of claim 27, further comprising the acts of:
adjusting the pH of the liquid portion of the second composition.

29. The method of claim 28, wherein a base is used floc the inorganic paint component and precipitate the organic paint component.

30. The method of claim 29, wherein the base is a strong base.

31. The method of claim 30, wherein the strong base is selected from the group consisting of lithium hydroxide, sodium hydroxide, potassium hydroxide, magnesium hydroxide, calcium hydroxide, or lime.

32. The method of claim 29, wherein an acid is used to floc the inorganic paint component and precipitate the organic paint component.

33. The method of claim 32, wherein the acid is a strong acid.

34. The method of claim 33, wherein the strong acid is sulfuric acid, phosphoric acid, nitric acid, hydrochloric acid, or methane sulfonic acid.

35. The method of claim 27, wherein the act of separating the paint solids from the liquid portion of the second composition to provide a solid portion comprises filtration or centrifugation.

36. The method of claim 35, wherein a filter aid is used to aid in filtration.

37. The method of claim 35, wherein the filtration comprises centrifugal filtration, gravity filtration, vacuum filtration, cold filtration, hot filtration, multi-layer filtration, mechanical filtration, surface filtration, depth filtration, or using a plate and frame filter press.

38. The method of claim 36, wherein said filter aid is diatomaceous earth, diatomite, perlite, or cellulose.

39. The method of claim 27, wherein an oxidizer is used in breaking the emulsion of said second composition.

40. The method of claim 39, wherein the oxidizer is bleach, hypochlorite, chloramine, a permanganate, ozone, or hydrogen peroxide.

41. The method of claim 28, wherein CO₂ is used to adjust the pH of the liquid portion of the second composition after filtration.

42. A method for treating a waste stream from flushing systems, the method comprising the acts of:
providing a composition wherein said composition comprises at least one suspended inorganic paint component and at least one dissolved organic paint component;
floccing the inorganic paint component and precipitating the organic paint component to provide a composition comprising a liquid portion and paint solids; and
separating the paint solids from the liquid portion of the composition.

43. The method of claim 42, further comprising the act of:
adjusting the pH of the liquid portion of the composition.

44-73. (canceled)

74. The method of claim 27 wherein the inorganic paint component comprises barium.

75. The method of claim 42, wherein the inorganic paint component comprises barium.
